(19) United States
(12) Patent Application Publication
(10) Pub. No.: US 2017/0334689 A1
(43) Pub. Date: Nov. 23, 2017

(54) PROCESS OF LIFTING AND TRANSITING A HEAVY OBJECT FROM A CONFINED SPACE

(71) Applicant: John R. Szarenski, St. Helen, MI (US)

(72) Inventor: John R. Szarenski, St. Helen, MI (US)

(21) Appl. No.: 15/597,818

(22) Filed: May 17, 2017

Related U.S. Application Data
(60) Provisional application No. 62/337,694, filed on May 17, 2016.

(51) Int. Cl. B66D 3/26; B66D 3/18

(52) U.S. Cl. CPC B66D 3/26; B66D 3/18

(57) ABSTRACT

A device and process for lifting and transiting a heavy object from a confined space is provided that increases the efficiency of repair of malfunctioning heavy appliances illustratively including hot water heaters. The device and process are able to adapt to a variety of obstacles and spatial challenges inherent in confined spaces where heavy appliances are frequently located. Additional benefits provided by the device and process are to reduce the risk of injury to a maintenance person working to repair a malfunctioning heavy appliance by allowing for the lifting and transiting of the appliance away from the confined space, thereby allowing for easier access and a larger working environment, while also reducing the risk of damage to property within, or in proximity to the confined space where a heavy appliance is located.

### CROSS-REFERENCE TO RELATED APPLICATION

This application claims priority of U.S. Provisional Patent Application Ser. No. 62/337,694 filed May 17, 2016, which is incorporated herein by reference.

### FIELD OF THE INVENTION

The present invention in general relates to a process of lifting and transiting a heavy object from a confined space; and in particular, to a process of assembling a portable transit lift in proximity to a heavy object to be transited, pivoting the portable transit lift within a confined space to facilitate attachment of a heavy object to the transit lift, and lifting and transiting a heavy object away from a confined space.

### BACKGROUND OF THE INVENTION

Structures, such as single family homes, apartment complexes and commercial buildings require a variety of heavy appliances to ensure that the use for which the structure was constructed can be maintained. For example, most structures, whether they be intended for residential or commercial use, require a hot water heater to ensure availability of hot water accessed through bathroom faucets, kitchen faucets, showers, and the like. Heavy appliances illustratively including hot water heaters can be cumbersome given their size and often awkward shape. In an effort to minimize the intrusion of these necessary, yet bulky objects on everyday use and enjoyment of a structure, building owners often elect to place the awkward and bulky appliances in a confined space, tucked away in the periphery of the building, so as to reduce intrusion on everyday use and aesthetics of the building.

Using a single-family home as an example, a bulky appliance such as a hot water heater is frequently located in the corner of a small closet, or in the basement if the home has one. Alternatively, bulky appliances are sometimes located in the corner of an auxiliary room. Given the cumbersome nature of these bulky appliances, building owners often avoid locating them in the center of a room so as to minimize their impact on space utilization. Even with advances in modern technology and reliability, heavy appliances inevitably malfunction necessitating repair. The weight and size of heavy appliances usually prohibit the appliances from being transported to a repair shop. As such, current industry practice requires a maintenance person to repair a malfunctioning heavy appliance on-site.

As a result, the maintenance person is required to repair the heavy appliance within the space in which the appliance was originally located—often a confined space. Given the weight of these objects, a maintenance person cannot move a heavy appliance from the confined space without risk of injury and/or damage to property. This presents a multitude of challenges for the maintenance person. For example, if the part needing repair is located in a hard-to-reach place on the appliance, such as under or behind the appliance, the maintenance person is forced to navigate the confined space by squeezing himself and/or his tools in any manner that eventually allows access to the malfunctioning part. This is not only inefficient, but can also be dangerous.

Current industry lifts for moving heavy appliances are not satisfactory in that they are themselves cumbersome and not amenable to assembly within, or in proximity to, the confined spaces where heavy appliances are frequently located. Furthermore, current industry lifts are rigid and not capable of adapting to the wide range of spatial obstacles and challenges inherent with these confined spaces. As a result, the full utility of current industry lifts is not realized because the lifts are limited by their ability, or lack thereof, of navigating and adapting to the varying obstacles and challenges inherent in confined spaces.

Thus, there exists a need for a process of lifting and transiting heavy objects and appliances illustratively including hot water heaters from a confined space using an apparatus that is capable of adapting to and overcoming the varying obstacles and challenges inherent in confined spaces where the objects are frequently located. There further exists a need for a process that makes maintenance of heavy appliances more efficient and also reduces the risk of injury to a maintenance person working to repair the heavy appliance, and also reduces the risk of damage to property within, or in proximity to the confined space.

### SUMMARY OF THE INVENTION

A process of lifting and transiting a heavy object from a confined space includes assembling a portable transit lift, attaching the lift assembly to the heavy item, lifting the heavy item, and transiting the heavy item away from the confined space by rolling a trolley along a center beam of the transit lift from a first end towards a second end, where the second end is distal to the confined space.

A portable transit lift is provided for lifting and transiting a heavy object from a confined space. The lift includes a center beam defining a track and having a first end and a second end. The lift further includes a first crossbeam and a second crossbeam with each of the crossbeams is adapted to receive one of the first or second ends of the center beam. Adjustable legs are removably engageable with each of the crossbeams. A rollable trolley is removably connected to the center beam, with a lift assembly removably connected to the rollable trolley. The lift assembly is adapted to attach to the heavy object.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a perspective view of a portable transit lift in accordance with a first embodiment of the invention;

FIG. 2 is a detail view of FIG. 1 showing the pivot bracket integral with the inner face of the first crossbeam, and the pivot bracket adapted to receive the first end of the center beam;

FIG. 3 is a perspective view of a portable transit lift in accordance with a second embodiment of the invention; and

FIG. 4 is another perspective view of a portable transit lift in accordance with the second embodiment of the invention showing the outer portions of the inventive lift.

### DESCRIPTION OF THE INVENTION

An inventive process for lifting and transiting a heavy object from a confined space is provided. Embodiments of the present invention have utility to increase the efficiency of repair of malfunctioning heavy appliances illustratively including hot water heaters. Embodiments of the present invention also have utility to adapt to a variety of obstacles and spatial challenges inherent in confined spaces where heavy appliances are frequently located. Embodiments of the present invention have additional utility to reduce the risk of injury to a maintenance person working to repair a malfunctioning heavy appliance by allowing for the lifting and transiting of the appliance away from the confined space, allowing for easier access and a larger working environment. Embodiments of the present invention have further utility to reduce the risk of damage to property within, or in proximity to the confined space where a heavy appliance is located. Additionally, be using interchangeable legs of variable lengths, objects can be moved over uneven or non-level areas safely. Specific use setting where extended leg lengths are employed include traversing a set of stairs and lowering objects into holes or pits. Similarly, by extending the length of the center beam, the length over which an object can be traversed can exceed 20 feet and even 30 feet.

It is to be understood that in instances where a range of values are provided that the range is intended to encompass not only the end point values of the range but also intermediate values of the range as explicitly being included within the range and varying by the last significant figure in the range. By way of example, a recited range from 1 to 4 is intended to include 1-2, 1-3, 2-4, 3-4, and 1-4.

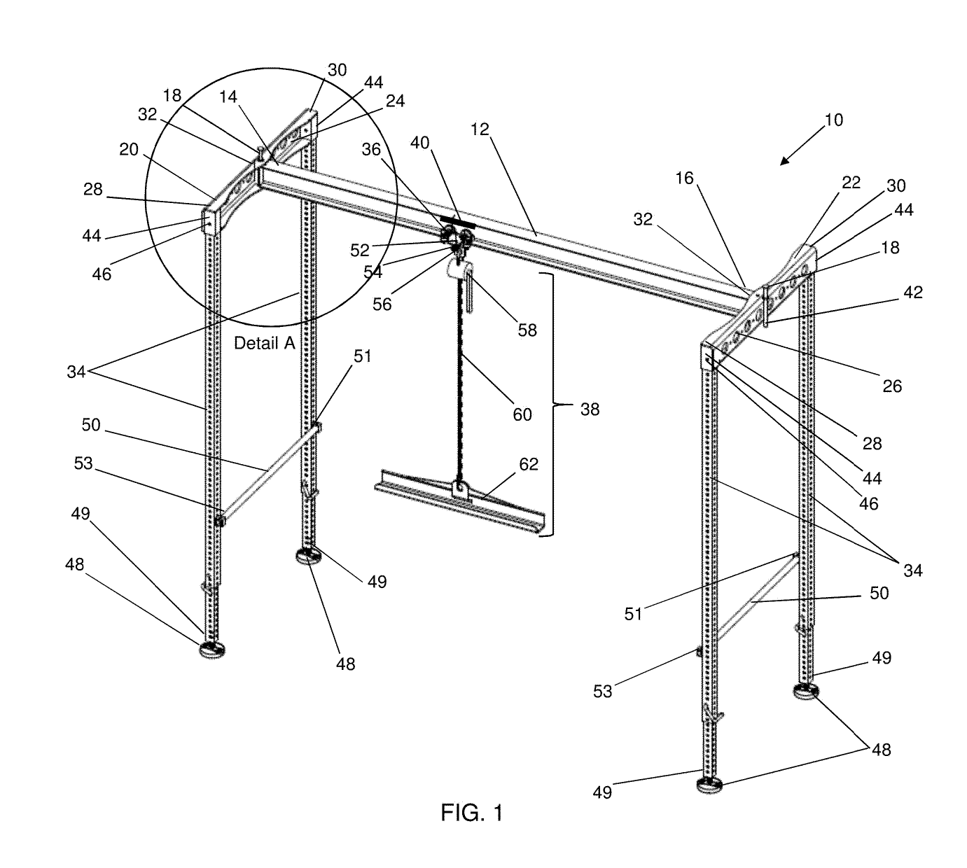

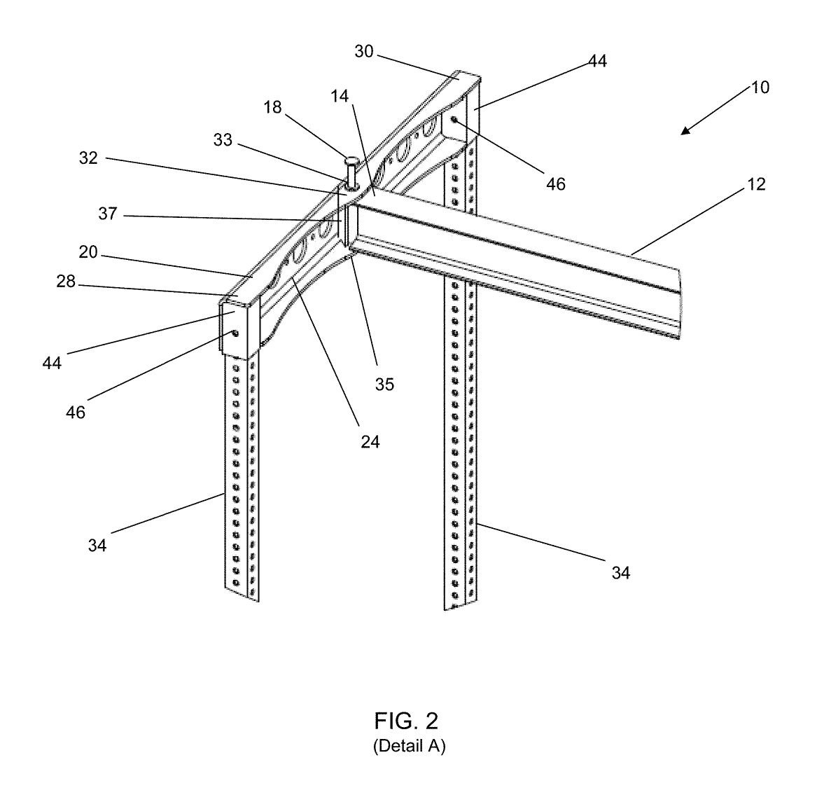

Referring now to the figures, FIG. 1 is a perspective view of portable transit lift shown generally at 10. FIG. 2 provides a detail view of the portable transit lift 10 has a center beam 12 defining a track, with a first end 14 and a second end 16 which is distal to the first end 14 relative to a longitudinal axis of the center beam 12. Both the first end 14 and the second end 16 have a cylinder 37 extending therethrough and oriented perpendicularly relative to the longitudinal axis of the center beam 12 which is adapted to receive a pivot pin 18. A first crossbeam 20 and a second crossbeam 22 both have an inner face 24, an outer face 26, a first crossbeam end 28, and a second crossbeam end 30. The inner face 24 and the outer face 26 of both the first crossbeam 20 and the second crossbeam 22 are oriented perpendicularly relative to a crossbeam longitudinal axis, where the second crossbeam end 30 is distal to the first crossbeam end 28 relative to the crossbeam longitudinal axis.

As best shown in conjunction with FIG. 2, pivot bracket 32 is integral with the inner face 24 of both first crossbeam 20 and second crossbeam 22, and the pivot bracket 32 is adapted to receive one of the first end 14 or second end 16 of the center beam 12. The pivot bracket 32 has a first pivot pin aperture 33 and a second pivot pin aperture 35, the second pivot pin aperture 35 being distal to the first pivot pin aperture 33 and each of the pivot pin apertures are adapted to receive the pivot pin 18. It is appreciated that each of the pivot pin apertures are in mechanical communication with the hollow cylinder 37 upon insertion of the pivot pin 18. It is further appreciated that insertion of the pivot pin 18 secures the center beam 12 to each of the first crossbeam 20 and the second crossbeam 22. The pivot pin 18 may include a locking mechanism 42.

A plurality of independently adjustable legs 34 are removably engageable with each of the crossbeams. A top end of each of the plurality of independently adjustable legs 34 may be inserted into a leg housing 44 adapted to receive the top end of each of the plurality of independently adjustable legs 34. The leg housing 44 may be integral with each of the first crossbeam end 28 and the second crossbeam end 30. It is further appreciated that each of the plurality of legs may be secured within the leg housing 44 with a lock bolt 46. A plurality of feet 48 may be attached to a bottom end 49 of each of the plurality of legs 34 where the bottom end 49 is distal to the top end of each of the plurality of legs 34. It is appreciated that attachment of the plurality of feet 48 provides for increased stability of the inventive portable transit lift 10. A support beam 50 may be secured to at least two of the plurality of legs 34 by attaching an end of a strut 51 to one of the at least two of the plurality of legs 34 and attaching a second support beam end 53 to the other of the at least two of the plurality of legs 34. The support beam 50 provides enhanced stability to the inventive portable transit lift 10.

A level 40 may be integral with the center beam 12, where the level 40 allows an operator of the portable transit lift 10 to confirm a desired orientation of the portable transit lift relative to a ground surface. A rollable trolley 36 is removably connected to the center beam 12. The rollable trolley 36 may have a trolley housing 52 with an integral vice grip component 54 and an integral hook 56. The vice grip component 54 is adapted to secure the rollable trolley 36 to the center beam 12, and the integral hook 56 is adapted to act as an attachment point for a lift assembly 38 which is removably connectable to the rollable trolley 36. The lift assembly 38 is adapted to attach to a heavy object. The lift assembly 38 further includes a winch 58 which is removably connected to the trolley housing 52, where the winch 58 has a chain 60 adapted to attach to a heavy object and is connected to a lift harness 62.

Embodiments of the inventive portable transit lift 10 may be assembled on-site, in proximity to a heavy object needing repair within a confined space. In some embodiments, the inventive portable transit lift 10 will be used to lift and transit a hot water heater from a confined space. The pivot brackets 32 allow embodiments of the inventive portable transit lift 10 to navigate and adapt to a variety of confined spatial obstacles and challenges. By way of non-limiting example, at least one of the first crossbeam 20 and second crossbeam 22 of the portable transit lift 10 may be pivoted between 0 and 45 degrees relative to a perpendicular orientation of the center beam 12 and at least one of the first crossbeam 20 and second crossbeam 22. Preferably, at least one of the first crossbeam 20 and second crossbeam 22 of the portable transit lift 10 is pivoted between 0 and 65 degrees relative to a perpendicular orientation of the center beam 12 and at least one of the first crossbeam 20 and second crossbeam 22. Most preferably, at least one of the first crossbeam 20 and second crossbeam 22 of the portable transit lift 10 is pivoted between 0 and 89 degrees relative to a perpendicular orientation of the center beam 12 and at least one of the first crossbeam 20 and second crossbeam 22. It is appreciated that the pivoting capability of the inventive portable transit lift 10 allows for the maneuvering of at least one of the plurality of legs 34 behind a heavy object needing repair relative to the confined space.

Upon attachment of the portable lift device 10 to a heavy object, lifting is achieved by engaging the winch 58. Once attached, a heavy object is transited away from a confined space by rolling the trolley 36 along the center beam 12 from the first end 14 toward the second 16 where the second end 16 is distal to the confined space. To further increase the efficiency of maintenance on a heavy object, further reduce the risk of injury to a maintenance person, and further reduce the risk of damage to property in proximity to a confined space, it is appreciated that the portable transit lift 10 may be optionally painted with at least one coating of phosphorescent paint. It is further appreciated that the at least one coating of phosphorescent paint facilitates assembly of the portable transit lift 10 in poor lighting conditions.

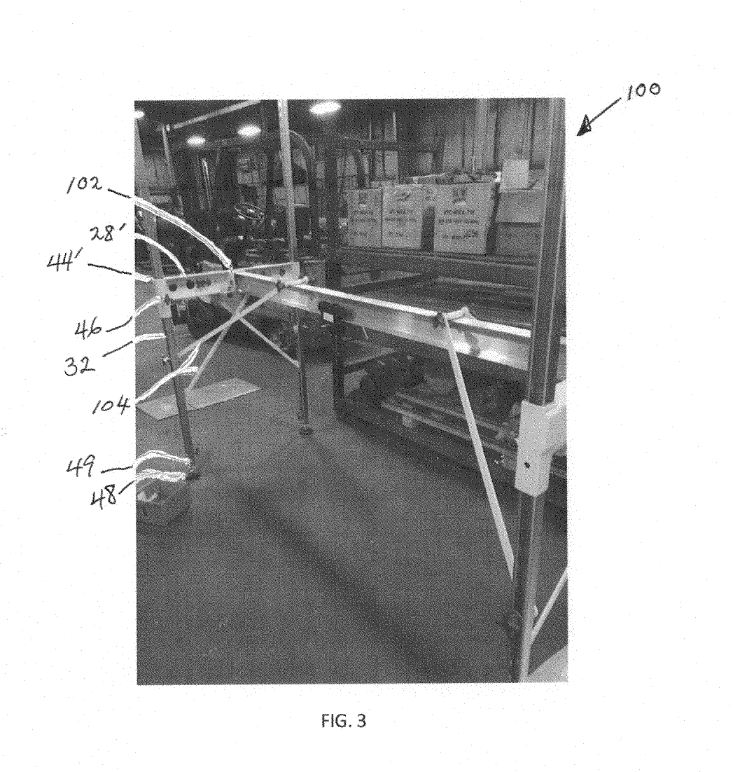

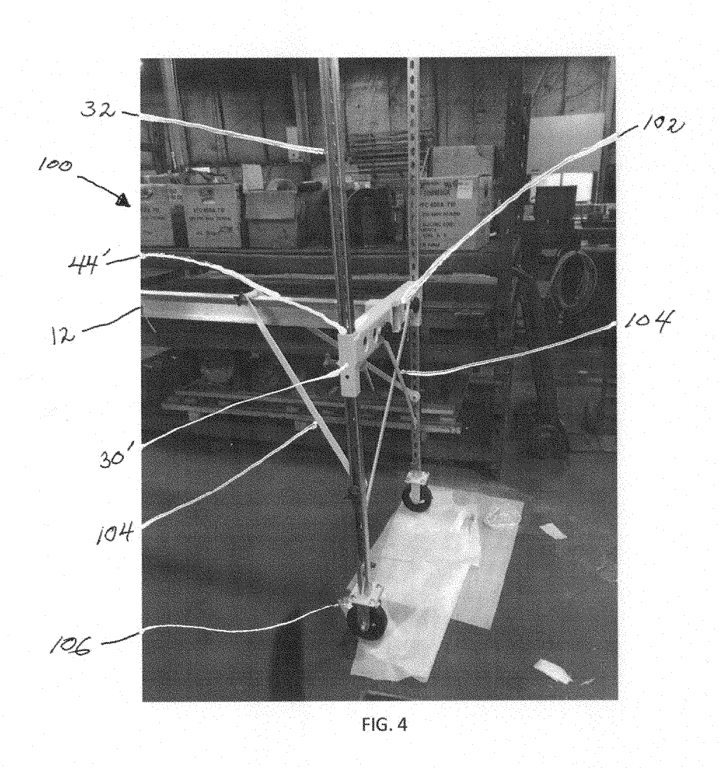

With reference to FIGS. 3 and 4 in which reference numerals have the meaning ascribed thereto with respect to FIGS. 1 and 2, a transit lift 100 is shown in general. In contrast, to the lift 10, the leg housing 44 is replaced with a leg housing 44′ that includes a through hole for receiving a leg 32. As a result, the relative height of the center beam 12 is highly dynamic and dictated only by the length of the conventional tubing used to define each leg 32. Also, in contrast to the lift 10, at least one of the first crossbeam end 28 and the second crossbeam end 30 are replaced with a crossbeam 28′ or crossbeam 30′, respectively that has a through hole 102 that is adapted to receive a center beam 12. As a result, the ability to pivot the center beam 12 relative to cross beams 28 and 30 is sacrificed in favor or a dynamic length of the center beam 12. A set of struts 104 retain the three-dimensional orientation between the legs 32-cross beams 28′ or 30′ and the center beam 12. Wheels 106 is attached at the bases 49 of the legs 32 to allow the lift 100 to roll into a desired position or carrying a heavy object.

As a person skilled in the art will recognize from the previous detailed description and from the figures and claims, modifications and changes can be made to the preferred embodiments of the invention without departing from the scope of this invention defined in the following claims.

1. A process of lifting and transiting a heavy object comprising:
assembling a portable transit lift, said portable transit lift comprising:
a center beam defining a track and having a first end and a second end, said second end being distal to said first end relative to a longitudinal axis of said center beam;
a first crossbeam and a second crossbeam suspending said center beam therebetween;
a plurality of independently adjustable legs removably engageable with each of said crossbeams; and
a lift assembly removably connected to a rollable trolley, said lift assembly adapted to attach to the heavy object;
positioning said portable transit lift within said confined space;
attaching a lift assembly movable attached to said center beam to the heavy item;
lifting said heavy item;
transiting said heavy item by rolling said lift assembly along said center beam.

2. The process of claim 1 wherein said heavy item is a hot water heater.

3. The process of claim 1 further adjusting the height of one of said plurality of independently adjustable legs by protruding said one of plurality of independently adjustable legs through a hole extending through said first crossbeam.

4. The process of claim 1 further comprising attached said plurality of independently adjustable legs to wheels and rolling said portable transit lift.

5. The process of claim 1 further comprising securing each of said plurality of legs within said leg housing with a lock bolt and struts.

6. The process of claim 1 further comprising adjusting the length of said center beam between said first cross beam and said second cross beam.

7. The process of claim 1 further comprising securing a strut to at least two of said plurality of legs, wherein a first strut end attaches to one of said at least two of the plurality of legs and a second strut end attaches to the other of said at least two of the plurality of legs.

8. The process of claim 1 wherein said lifting assembly further comprises a rollable trolley having a trolley housing with integral vice grip component and integral hook, said vice grip component adapted to secure said rollable trolley to said center beam and said hook adapted to act as an attachment point for said lift assembly.

9. The process of claim 1 wherein said lift assembly further comprises a winch removably connectable to said trolley housing, said winch having a chain connected to a lift harness, said chain adapted to attach to said heavy object.

10. The process of claim 9 wherein said lifting is achieved by engaging said winch.

11. The process of claim 1 further comprising disassembling said portable transit lift, wherein said disassembling facilitates efficient transport from said confined space.

12. A portable transit lift for lifting and transiting a heavy object from a confined space, said lift comprising:
a center beam defining a track and having a first end and a second end, said second end being distal to said first end relative to a longitudinal axis of said center beam;
a first crossbeam and a second crossbeam suspending said center beam therebetween;
a plurality of independently adjustable legs removably engageable with each of said crossbeams; and
a lift assembly removably connected to a rollable trolley, said lift assembly adapted to attach to the heavy object.

13. The lift of claim 12 further comprising a pivot pin securing said center beam to one of said first crossbeam or said second crossbeam.

14. The lift of claim 13 wherein said pivot pin further comprises a locking mechanism.

15. The lift of claim 12 further comprising at least one through hole in said first cross beam for selectively extending therethrough and securing one of said plurality of independently adjustable legs or said center beam.

16. The lift of claim 12 further comprising a level integral with said center beam.
